(19) United States
(12) Patent Application Publication
(10) Pub. No.: US 2008/0049218 A1
(43) Pub. Date: Feb. 28, 2008

(54) Substrate inspection device and lamp unit used therein

(75) Inventor: Hiroaki Kido, Ina-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 11/881,225

(22) Filed: Jul. 26, 2007

(30) Foreign Application Priority Data
Jul. 27, 2006 (JP) P2006-204349

(51) Int. Cl. G01N 21/00

(52) U.S. Cl. 356/237.1

(57) ABSTRACT

In this invention, having as an object the facilitation of replacement of a lamp light source in a substrate inspection apparatus with heightened cleanliness within the apparatus, a substrate inspection apparatus is configured to enable visual inspections of substrates performed directly by an inspector using a macro illumination device. The macro illumination device has a light source device in a high-cleanliness portion above a micro inspection portion. The light source device is configured to enable replacement of the internal lamp from a front-wall door. The light source device is positioned in a first region having a lower degree of cleanliness compared with the region in which substrates are handled, so that even when replacement of the lamp of the light source device is performed, the cleanliness of the region in which substrates are handled is maintained.

### BACKGROUND OF THE INVENTION

1. Field of the Invention

This invention relates to a substrate inspection apparatus enabling inspection of semiconductor wafers and other substrates both visually and by microscope, and to a lamp unit used in a substrate inspection apparatus.

This application claims priority from Japanese Patent Application No. 2006-204349, filed on Jul. 27, 2006, the entire contents of which are incorporated herein by reference.

2. Description of the Related Art

In manufacturing processes to form circuits on a semiconductor wafer or other substrate, and in processes to form patterns on glass substrates to manufacture liquid crystal displays or other flat panel displays, processes for visual macroscopic inspection of the external appearance of the substrate (macro inspection processes), and processes for micro-inspection by means of enlarged observation using a microscope (micro inspection processes), are performed. A substrate inspection apparatus used in such inspections is integrally provided with a macro inspection portion to perform macro inspections, and a micro inspection portion to perform micro inspections, and is configured so as to perform macro inspections and micro inspections in order (see for example International Patent Publication No. WO2002/021589). A macro inspection portion has a mechanism to raise the substrate toward the inspector, and a macro illumination device to illuminate the substrate from above. A macro illumination device comprises a light source device and an illumination optical system to uniformly irradiate the substrate, switching between diffuse light and converging light.

Among substrate inspection apparatuses of the prior art, there are apparatuses in which the macro inspection portion and micro inspection portion are enclosed and clean air is blown so as to create an environment which locally is highly clean (mini-environment structure), in order that dust does not adhere to the substrate. In such a substrate inspection apparatus, high-cleanliness air is blown in the interior and the pressure within the apparatus is set higher than that of the outside environment, so that outside dust is not sucked into the device, and a high degree of cleanliness is maintained within the apparatus. In an apparatus with this configuration, if a worker places a hand or other object into an area of high cleanliness in the apparatus to perform a task, the cleanliness within the apparatus is reduced, and so constituent components which may be touched by humans performing tasks are placed outside the apparatus. The lamp of the light source device in the macro illumination device described above, and other elements, may require periodic replacement, and so are placed in a portion exposed to the outside in the lower portion of the apparatus. As a result, in conventional substrate inspection apparatus, a light guide is positioned along the device to guide light from the light source apparatus to the illumination optical system positioned on the upper side of the apparatus.

### SUMMARY OF THE INVENTION

In a conventional light source device, an IR (infrared ray) cutoff filter, heat absorption filter, and other optical components may be provided in addition to a lamp; when replacement of such optical components is included, the frequency of replacement increases, and replacement tasks become troublesome, and so development of equipment enabling easy replacement of lamps and other optical components has been desired.

In a substrate inspection apparatus of this invention, having an inspection portion in which clean fluid is made to flow within the apparatus and which has higher cleanliness than the exterior, and configured such that visual inspections of substrates by direct observations by an inspector and enlarged observation using a microscope can be performed in the inspection portion, a light source device is positioned within the inspection portion and above the microscope to illuminate the substrate, and to illuminate the substrate when performing visual inspections.

### BRIEF DESCRIPTION OF THE DRAWINGS

FIG. 1 shows in summary the configuration of the substrate inspection apparatus of the present invention;

FIG. 2 is a cross-sectional view along line A-A in FIG. 1;

FIG. 3 is a cross-sectional view along line B-B in FIG. 1;

FIG. 4 is a cross-sectional view along line C-C in FIG. 1, showing the configuration of the light source device;

FIG. 5 is a perspective view showing the lamp unit; and,

FIG. 6 is a cross-sectional view along line D-D in FIG. 4.

### DESCRIPTION OF THE PREFERRED EMBODIMENTS

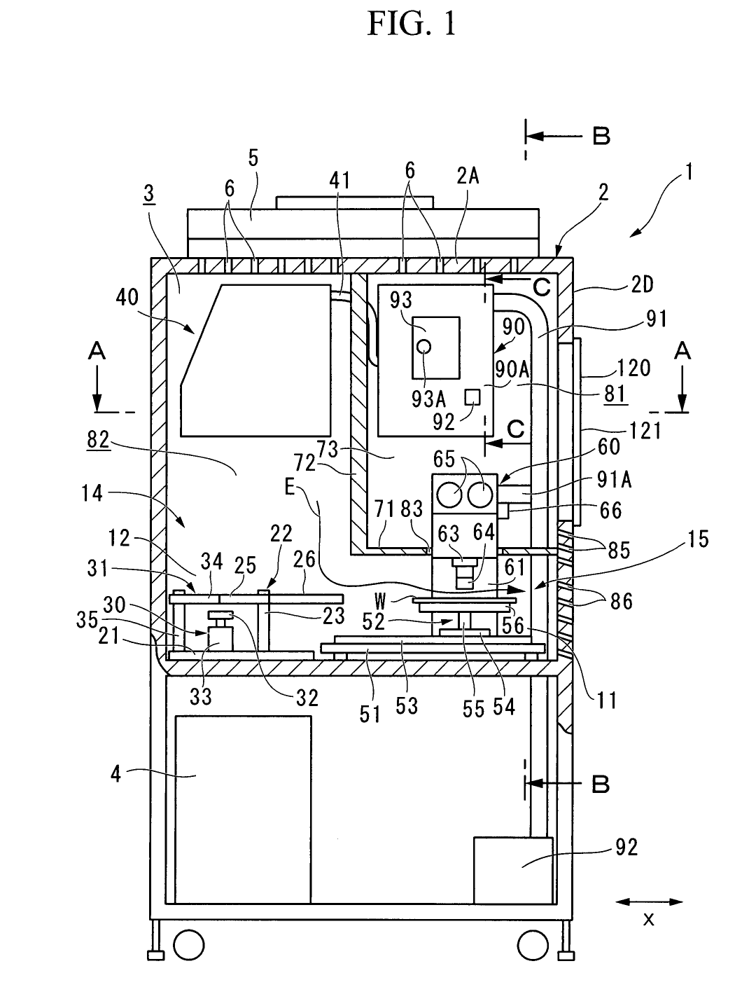

A preferred embodiment of the present invention is explained in detail referring to the drawings. FIG. 1 shows an apparatus configuration, and is a schematic drawing which simplifies the front panel, except for the light source device.

As shown in FIG. 1, the substrate inspection apparatus 1, used to inspect semiconductor wafers or other substrates, has an apparatus main unit 2 installed on the floor surface, and a high-cleanliness portion 3 (inspection portion) is partitioned in the upper portion of the apparatus main unit 2, as a space for inspecting wafers W. In the lower portion of the apparatus main unit 2, a control device 4 which controls the apparatus is installed open to the outside, and a suction pump (not shown) to hold the substrate W by suction-clamping is also installed.

The high-cleanliness portion 3 enables clean air (a clean fluid), generated by the filter fan unit 5, to flow in from the ceiling portion 2A of the apparatus main unit 2, forming a mini-environment structure with higher cleanliness than the exterior environment. The filter fan unit 5 is a clean fluid provider, having a fan which takes in outside air existing around the substrate inspection apparatus 1 and blowing the air within the high-cleanliness portion 3 from a plurality of holes 6 formed in the ceiling portion 2A, and a filter, provided between the fan and the holes 6, which removes dust in the outside air.

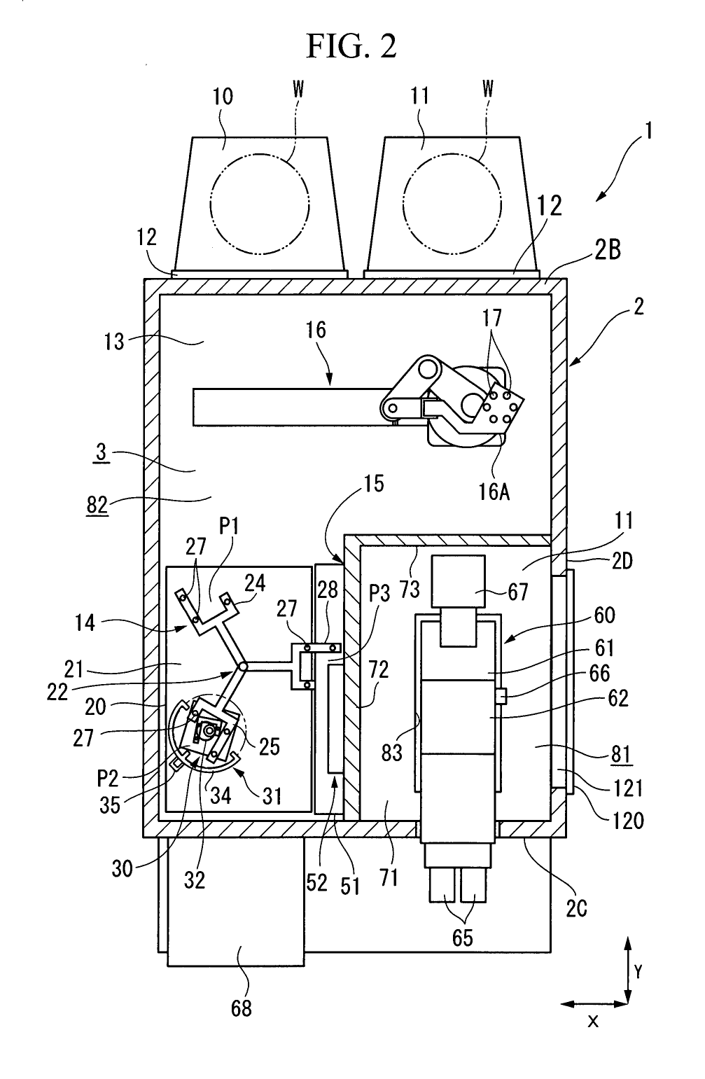

As shown in FIG. 2, two loading ports 12, which mount substrate carriers 10, 11 accommodating numerous substrates W, are provided on the rear face 2B side of the apparatus main unit 2 in a plane view. The high cleanliness portion 3 has a loading portion 13 which transports substrates W to the rear face 2B side; a macro inspection portion 14 and a micro inspection portion 15 are formed side by side on the front face 2C side with respect to the loading portion 13 so as to be on the right and left as seen by an inspector.

One automated substrate transport unit 16 is provided in the loading portion 13, moveable in one axial direction. The substrate transport robot 16 is an articulated arm with a plurality of joints which transports substrates W between the substrate carriers 10, 11 installed on the rear face 2B of the apparatus main unit 2 and the macro inspection portion 14; a plurality of suction-clamping holes 17 for suction clamping on the tip-portion arm 16A are provided to hold a substrate W.

The macro inspection portion 14 is an inspection portion to perform visual inspections by an inspector; a swivel arm 22 is installed on an inspection pedestal 21 so as to be freely rotatable. The swivel arm 22 has a rotation shaft 23 extending in the vertical direction, and three arms 24, 25, 26 are provided from the tip of the rotation shaft 23, in substantially horizontal directions and extending radially from the rotation shaft 23. A plurality of suction-clamping holes 27 to hold substrates W by suction-clamping are provided at the tip portions of each of these three arms 24 through 26.

Rotation of the swivel arm 22 is controlled by the control device 4 such that the arms 24 through 26 are arranged at one of the positions P1, P2 or P3. Position P1 is a transfer position to transfer a substrate W to and from the automated substrate transport unit 16, position P2 is an inspection position for performing macro inspections, and position P3 is a transfer position to transfer a substrate W to the micro inspection portion.

Here, a top surface inspection portion 30 and rear surface inspection portion 31 are provided at position P2. The top surface inspection portion 30 has a support portion 32 (rotating-pivoting table) which supports the center of a substrate W from below, and an elevating mechanism 33 which elevates the support portion 32 to a higher position than the swivel arm 22. The support portion 32 is provided with an oscillating mechanism, which lifts and oscillates the top surface of the substrate W toward the inspector on the front face 2C side, and a mechanism which rotates the substrate W about a vertical shaft passing through the center of the support portion 32. The rear surface inspection portion 31 has a holding portion 34 which holds by suction-clamping the rear surface of the substrate W at the outer periphery, and an elevating mechanism 35 which elevates the holding portion 34 to a position higher than the swivel arm 22. A mechanism to cause rotation of the rear surface of the substrate W toward the inspector is provided in the holding portion 34.

A macro illumination device 40 which illuminates the wafer W is positioned above the top surface inspection portion 30 and rear surface inspection portion 31. An illumination optical system used to illuminate the substrate W is housed in the macro illumination device 40. As the illumination optical system, for example, a Fresnel lens which forms a converging light beam from light guided by the light guide 41 and a liquid crystal plate positioned in the optical path may be used. The illumination light can be made to become diffuse light upon passing through the liquid crystal plate.

The micro inspection portion 15 has an inspection stage 52 positioned above the inspection pedestal 51. In the inspection stage 52, an X-axis stage 53 extending in the X direction toward position P3 and a Y-axis stage 54 which is freely moveable in the Y direction perpendicular to the X direction are stacked vertically, to enable motion in the directions of the two XY axes. A rotation shaft 55 extends in the vertical direction from the upper Y-axis stage 54. The rotation shaft 55 is supported so as to enable vertical movement and rotation; a holding plate 56, on which a substrate W is placed is fixed on the tip portion thereof. Suction-clamping holes (not shown) to hold the substrate W by suction-clamping are formed in the holding plate 56.

Further, a microscope 60 for enlarged observation of the surface of the substrate W on the inspection stage 52 is fixed onto the inspection pedestal 51 of the micro inspection portion 15. The microscope 60 has a microscope main unit 61 extending upward from the rear face 2B beyond the inspection stage 52; the lens barrel 62 extends toward the front face 2C from the microscope main unit 61. In the lower portion of the lens barrel 62, an objective lens 64 is replaceably mounted on the rotating revolver 63. An ocular lens 65 is mounted on the front face of the lens barrel 62. A knob 66 or similar to switch color filters is provided on a side of the lens barrel 62, and a lamp housing 67 which houses a lamp, used as the illumination light source, is installed on the rear face of the lens barrel 62.

Here, in the micro inspection portion 15, the space above the inspection stage 52 is divided by dividing plates 71, 72, 73 into a region in which the substrate W moves (micro inspection region) and an isolated region (first region 81) where the upper portion of the microscope 60 is positioned. The micro inspection region is demarcated, together with the macro inspection portion 14 and loading portion 13, in a second region 82 belonging to the high-cleanliness portion 3. In this embodiment, the pressure within the first region 81 is higher than that outside the high-cleanliness portion 3, but is lower than the pressure within the second region 82, so that the cleanliness in the first region 81 is low relative to the cleanliness in the second region 82. As a mechanism of providing a difference in cleanliness due to the pressure difference, for example, the number of holes 6 which pass clean air from the filter fan unit 5 may be such that the number of holes in the ceiling portion of the second region 82 side is greater than the number of holes in the ceiling portion 2A of the first region 81 side, or the diameters of holes 6 on the second region 82 side may be made larger than the diameters of holes 6 on the first region 81 side.

The dividing plate 71 is positioned above the inspection stage 52, and is provided with an aperture portion 83 through which the microscope main unit 61 passes. The dividing plate 72 extends substantially in the vertical direction without protruding into the macro inspection portion 14, and is fixed to the ceiling portion 2A of the apparatus main unit 2. The dividing plate 73 closes off the rear-face side of the first region 81. The front-face side of the first region 81 is closed off by the front-face panel of the apparatus main unit 2. The side opposite the dividing plate 72 is closed off by the side portion 2D of the apparatus main unit 2; a plurality of exhaust slits 85 are formed in the lower portion thereof, effecting the exhaust of clean air from the ceiling portion 2A. Further, a plurality of exhaust slits 86 are formed in the side portion 2D below the dividing plate 71, and clean air flowing into the micro inspection region in the environs of the inspection stage 52, through the macro inspection portion 14, is discharged to the outside. Instead of forming the slits 85, 86, metal punching or similar may be used. Also, the clean air may be discharged to the outside from gaps or similar formed in the lower face of the high-cleanliness portion 3.

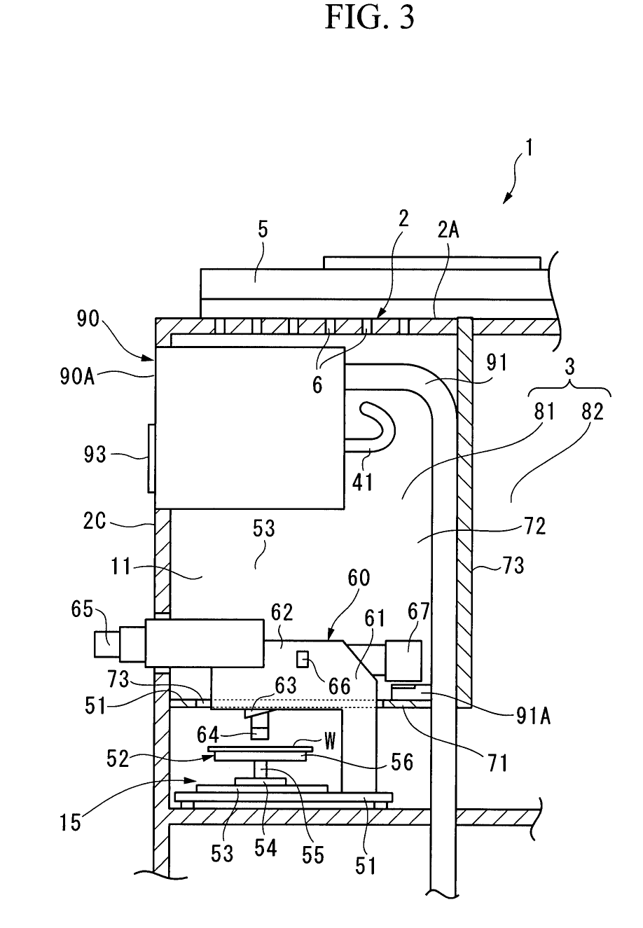

As shown in FIG. 1 and FIG. 3, the light source device 90 of the above-described macro illumination device 40 is provided on the side of the front face 2C above the ocular lens 65 of the microscope 60 in the upper portion of the first region 81.

The light source device 90 is formed in a box shape, and a duct 91 is connected on the rear-face side. The duct 91 passes through the interior of the high-cleanliness portion 3 and leads to a portion which is open to the outside in the bottom portion of the apparatus main unit 2; an exhaust fan 92 provided at the end portion thereof can forcibly discharge clean air in the light source device 90 to the outside. In addition, the duct 91 has a branch pipe 91A extending along the side of the lamp housing 67 of the microscope 60, and can cool the lamp housing 67 and discharge gases generated during lighting of the lamp.

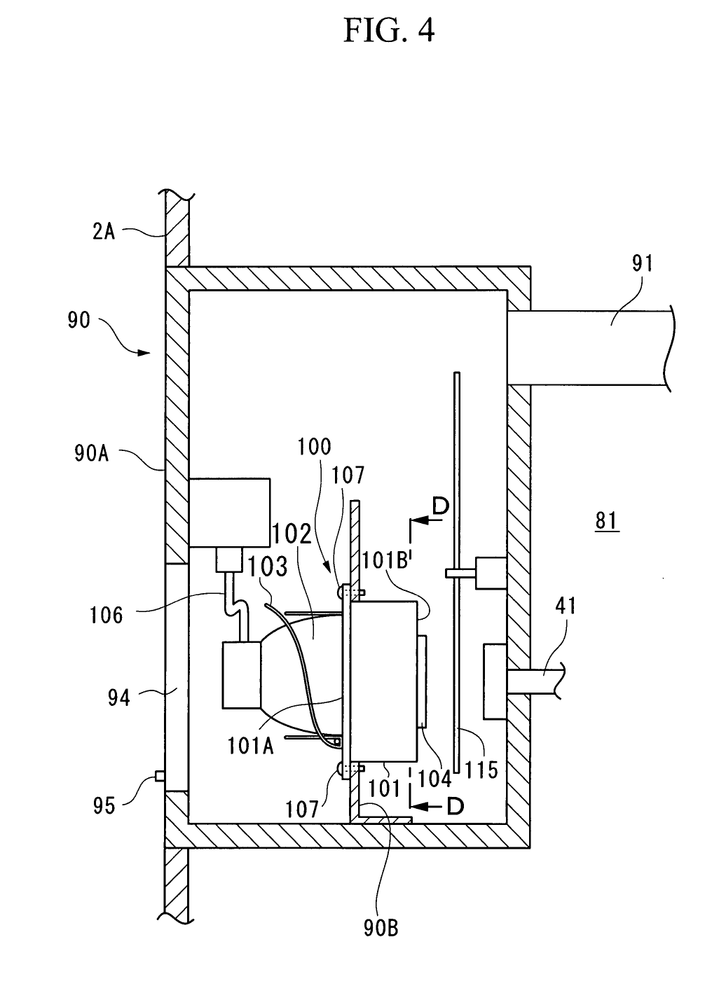

The front wall 90A of the light source device 90 is fitted into the front-face panel of the apparatus main unit 2 and exposed to the outside. The front wall 90A is provided with an hour meter 92 and similar, and is also provided with an opening-and-closing front-wall door 93. The front-wall door 93 can be fixed to the main unit of the light source device 90 with screws 93A. As shown in FIG. 3 and FIG. 4, when the front-wall door 93 is opened, the lamp unit 100 housed within the light source device 90 appears. A switch 95 to detect the opening and closing of the front-wall door 93 is provided on a peripheral portion of the window 94 formed when the front-wall door 93 is opened. This switch 95 is used as an interlock mechanism when the light source device 90 is lit.

The lamp unit 100 has a substantially square housing box 101; the lamp 102 is fixed to a mounting fixture 103 on one face 101A of the housing box 101. A filter 104, serving as an illumination optical component, is mounted in another face 101B positioned opposing the one face 101A. The filter 104 comprises an IR cutoff filter and a heat absorption filter.

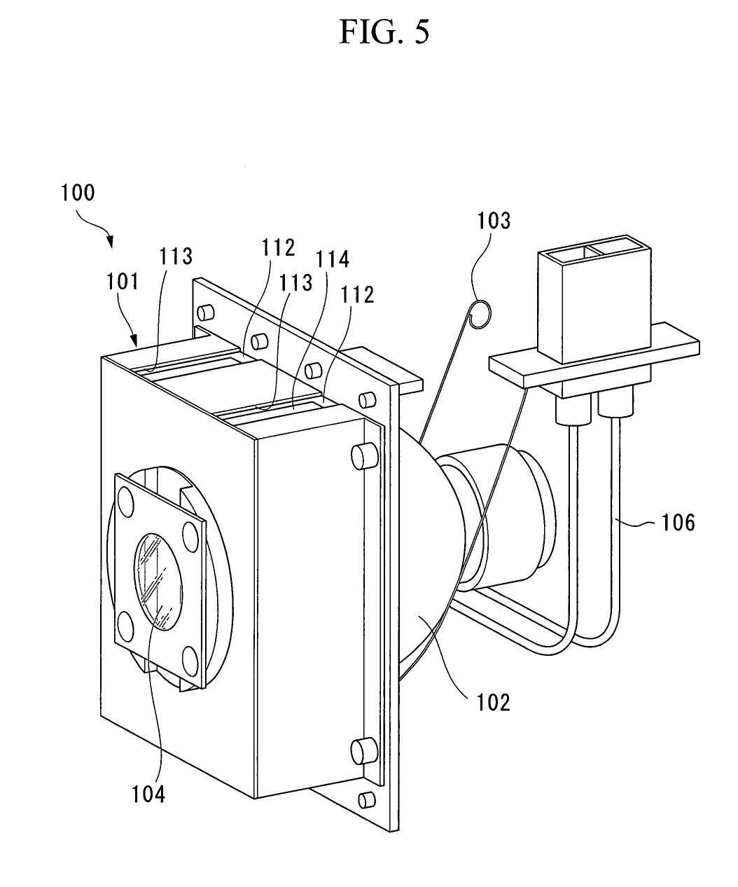

As shown in FIG. 5, the filter 104 is fixed with screws to the housing box 101 via an adapter in which is formed a groove such that, by causing air to flow, the filter 104 can be cooled.

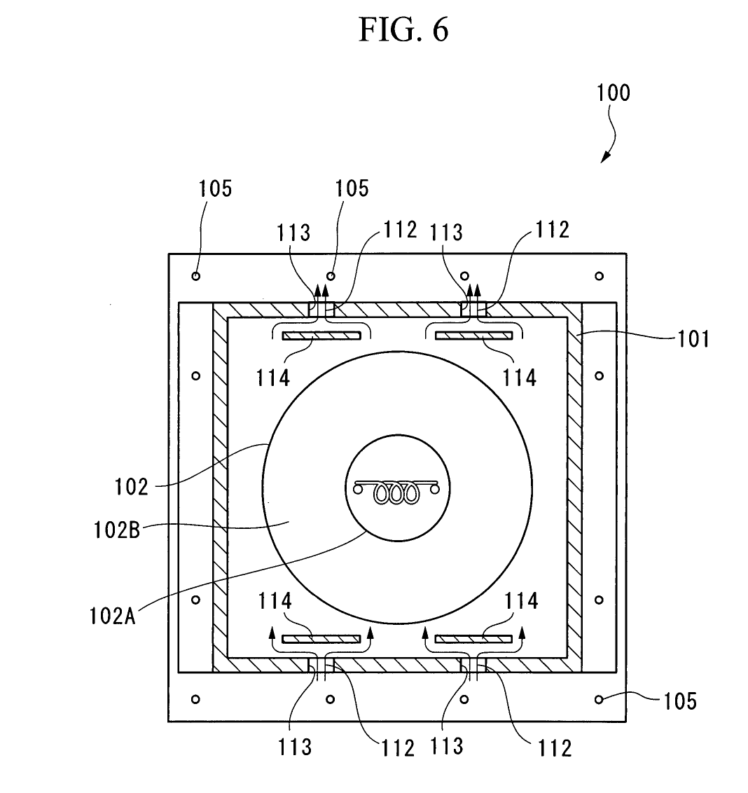

As shown in FIG. 4 through FIG. 6, the peripheral portion of side of one face 101A of the housing box 101 is extended outward, and a plurality of holes 105 employed to fasten with screws the lamp unit 100 to the bracket 90B on the side of the light source device 90 are formed thereof. As shown in FIG. 6, in the housing box 101, two passages 112 each are formed, with an interval therebetween, in the floor portion 110 and in the ceiling portion 111. The passages 112, together with slits 113 formed in the floor portion 110 and in the ceiling portion 111 of the housing box 101, and with long narrow plates 114 positioned on the inside of the positions of formation of each of the slits 113, make up a labyrinth shape. The distance between the slits 113 and plates 114 is such that clean air can pass through, but such that a solid constituent component of the lamp 102, such as for example a piece of the bulb 102A resulting when the bulb is broken during installation of the lamp 102, cannot pass through. By this means, even when there is breakage, recovery of broken pieces is easily accomplished by replacing the entire housing box 101. The lamp 102 is fixed such that the opening of the reflector 102B surrounding the bulb 102A which houses the filament is directed toward the interior of the housing box 101.

A rotating-type color filter 115 is positioned in the front face of the filter 104 of the lamp unit 100. The color filter 115 is used when changing the color of illumination light used to illuminate the substrate W. The color filter 115 is used when identification of faults on the substrate W is easier depending on the color of the illumination light, but is not an essential component of this embodiment. In addition, the end face of a light guide 41 is fixed at a predetermined position on the optical path of light emitted from the lamp unit 100.

Next, the action of this embodiment is explained.

When performing substrate inspections, a substrate carrier 10 housing substrates W to be inspected and an empty substrate carrier 11 are loaded into the loading ports 12. The automated substrate transport unit 16 takes one substrate W from the substrate carrier 10, and passes the substrate W to the arm 24 standing by at position P1 of the macro inspection portion 14. When the arm 24 holds the substrate W by suction-clamping, the swivel arm 22 rotates about the rotation shaft 23 and moves the substrate W to position P2. At position P2, the suction-clamping by the arm 24 is released, and the substrate W is held by suction-clamping by the top surface inspection portion 30. The elevating mechanism 33 is driven to raise the support portion 32, and the top surface of the substrate W is illuminated with illumination light from the macro illumination device 40 provided above. The support portion 32 is made to oscillate and otherwise move, and the inspector, who is on the front face 2C side, visually inspects for the presence of defects and so on through an observation window in the apparatus main unit 2. When the inspection is completed, the substrate W is lowered. When performing a rear surface inspection, the substrate W is passed to the rear surface inspection portion 31. The rear surface inspection portion 31 raises the substrate W, and also lifts the substrate W such that the rear surface of the substrate W is facing the inspector. When the rear surface of the substrate W has been inspected using illumination light from the macro illumination device 40, the rear surface inspection portion 31 is lowered, and the substrate W is once again passed to the arm 24.

The control device 4 causes the swivel arm 22 to rotate further and transport the substrate W to position P3. At position P3, the inspection stage 52 of the micro inspection portion 15 is standing by, and so the substrate W is passed to the inspection stage 52. The other two arms 25 and 26 move in order to position P1 according to rotation of the swivel arm 22, and so new substrates W are loaded in order by the automated substrate transport unit 16. The substrates W placed on the other two arms 25 and 26 are transported to the inspection position at position P2 in order by rotation of the swivel arm 22. By this means, a plurality of substrates W are continuously subjected to macro inspection.

In the micro inspection portion 15, the inspection stage 52 is driven to transport the substrate W to below the objective lens 64 of the microscope 60. The inspector acquires an enlarged image of the top surface of the substrate W via the microscope 60. The enlarged image of the top surface of the substrate W can be examined through the ocular lens 65 positioned on the front face 2C of the apparatus main unit 2, or may be displayed on a display 68 (see FIG. 2). After the top surface of the substrate W has been inspected by means of the enlarged image, the substrate W is returned to position P3 and is passed to the arm 24. The swivel arm 22 rotates, and the substrate W for which macro inspection and micro inspection have been completed is returned to position P1. This substrate W is then transported outside by the automated substrate transport unit 16, and is stored in the substrate carrier 11.

While performing inspections, clean air from the filter fan unit 5 in the upper portion is forcibly blown, so that there is a positive pressure with respect to the outside within the high-cleanliness portion 3. Clean air which is blown toward the vicinity of the macro inspection portion 14 and the automated substrate transport unit 16 flows primarily through the micro inspection region in the vicinity of the inspection stage 52, as indicated by arrow E in FIG. 1, and is discharged to the outside from the exhaust slits 86. A portion of the clean air is blown from the apertures of the dividing plate 71 into the first region 81. In the first region 81, clean air is forcibly blown from the filter fan unit 5, and is discharged to the outside from exhaust slits 85 formed in a side portion of the apparatus main unit 2. In this way, by maintaining the high-cleanliness portion 3 at a positive pressure, the contamination of dust from outside is prevented, and moreover by means of the flow of clean air, adhesion of dust on the surface of the substrate W is prevented.

Here, when a macro inspection is performed, the lamp 102 housed in the first region 81 is lighted. The illumination light emitted by the lamp 102 passes through the filter 104 (IR cutoff filter, heat absorption filter) and is emitted from the lamp unit 100. When a rotating color filter 115 is provided, illumination light which has passed through the color filter 115 is incident on the light guide 41. The light guide 41 extends from the light source unit 90, passing through the dividing plate 72 which divides the first region 81 and the adjacently positioned high-cleanliness portion 3, and is connected to the macro illumination device 40. Illumination light guided by the light guide 41 is emitted from the upper portion of the macro illumination device 40, passing through a Fresnel lens and liquid crystal plate to irradiate the substrate W.

During macro inspection, the lamp 102 emits heat. Also, when the lamp 102 is a halogen lamp or similar, ozone is emitted. The heat and ozone from the lamp 102 is discharged to the outside of the high-cleanliness portion 3 from the duct 91 by the clean air flowing in the housing box 101 through the passage 112 of the lamp unit 100. Furthermore, depending on the type of lamp 102, there are cases in which the bulb 102A may crack. In such cases, because the aperture area of the passage 112 is small compared with the size of glass pieces from the broken bulb 102A and similar, glass pieces or similar do not fly outside the apparatus from the passage 112, but remain within the housing box 101.

When replacing the lamp 102 of the macro illumination device 40, the front-wall door 93 is opened. When the front-wall door 93 is opened, the switch 95 is turned off, the interlock mechanism is activated, and the power supply to the lamp 102 is turned off. After unplugging the power cord 106, the screws 107 fastening the lamp unit 100 in place are removed. The used lamp unit 100 is removed, the new lamp unit 100 is inserted, and is screwed onto the bracket 90B. When the front-wall door 93 is closed, the switch 95 is turned on, and the interlock mechanism is cancelled. While the front-wall door 93 is open, the air within the light source device 90 is forcibly discharged outside from the duct 91, so that the cleanliness in the first region 81, in which the light source device 90 is positioned, is not greatly reduced. The second region 82, in which substrates W are actually handled, is further isolated from the first region 81 by the dividing plates 71 to 73, so that there is almost no decline in the cleanliness of the second region 82.

Further, when replacing the lamp within the lamp housing 67 of the microscope 60, the external door 120 of the side portion 2D of the apparatus main unit 2 is opened, and a hand is inserted from the opening 121 to replace the lamp within the lamp housing 67 with a new lamp. When lamp replacement is completed, the external door 120 is used to close the opening 121. By opening the external door 120 to perform manual tasks within the first region 81, the cleanliness in the first region 81 is temporarily degraded, but there is almost no reduction in the cleanliness of the second region 81 which is isolated by the dividing plates 71 to 73.

According to this embodiment, because the light source device 90 of the macro illumination device 40 is positioned within the high-cleanliness portion 3 and in the upper portion thereof, the length of the light guide 41 can be shortened, and light losses can be reduced. Further, during replacement of the lamp 102 the worker need not bend forward, but can perform tasks in an upright position relative to the inspection apparatus, so that working conditions are improved.

The substrate inspection apparatus 1 is partitioned into two regions according to degree of cleanliness, and the light source device 90 is positioned in the first region 81, in the portion above the microscope 60 in which a relatively low degree of cleanliness is allowed. Hence there is no decline in cleanliness in the second region 82, in which substrates W are handled, due to the existence of the light source device 90 or due to lamp replacement. Each time lamp replacement is performed, the need to stop the apparatus and stand by until high cleanliness is attained can be eliminated, so that inspection efficiency is improved.

The clean air within the light source device 90 is forcibly discharged to the outside by the duct 91 and fan 92, so that leaking of ozone or other gases, and accumulation of heat at the lamp 102 or in the housing box 101, can be prevented.

The lamp unit 100 has a housing box 101 surrounding the glass portion of the lamp 102, so that falling of pieces of the glass portion outside the housing box 101 can be reliably prevented. Further, passages 112 which pass only clean air are formed in the housing box 101, so that while preventing the falling of foreign objects, the lamp 102 can be cooled.

This invention is not limited to the above aspect, but can be applied over a wide range. For example, the configuration and number of passages 112 in the housing box 101 may be of any shape and number, so long as the lamp can be cooled while preventing the falling of foreign objects. Passages 112 may be added to the side portions of the housing box 101. Numerous minute holes may be formed in the housing box 101, to form passages which pass only clean air.

A configuration is possible in which, instead of enabling replacement of the lamp unit 100 from the front face 2C side, replacement is possible from a side portion of the apparatus main unit 2.

Further, in a substrate inspection apparatus of this invention, instead of substrate inspection by direct observation by an inspector and enlarged observations using a microscope 60, images of surfaces of the substrate W for inspection may be captured automatically by an image capture device. The apparatus main unit 2 may have a mini-environment structure, and the light source device 90 may be separated from the region in which substrates W are handled by partitioning the interior of the mini-environment structure. A door used when replacing the lamp and so on may be on the front panel side, and in particular, if the door is in the upper portion of a display used for inspections, advantageous results similar to those of the above-described embodiment are obtained.

According to the lamp unit used in a substrate inspection apparatus of this invention, replacement of the lamp of the light source device is made easy. Only a small amount of time for replacement is required, and the inspection portion is isolated from the lamp unit, so that the replacement task can be completed without greatly reducing cleanliness in the inspection portion. During use of the illumination device, air passing through passages and flowing within a housing box cools the lamp, so that the lamp lifetime is lengthened.

What is claimed is:

1. A substrate inspection apparatus, comprising:
an inspection portion, in which the degree of cleanliness is increased compared with the outside by causing a flow of clean fluid within the apparatus; and,
a light source device of an illumination device, within the inspection portion and above the inspection position of the substrate within the inspection portion, which illuminates the substrate.

2. The substrate inspection apparatus according to claim 1, comprising a macro inspection portion for performing visual inspections of a substrate by direct observations within the inspection portion and a micro inspection portion for performing visual inspections through enlarged observations, wherein
the light source device of the illumination device, which illuminates the substrate when in the macro inspection portion, the substrate is illuminated and visual inspections are performed, is provided within the inspection portion and above the micro inspection portion.

3. The substrate inspection apparatus according to claim 2, wherein the light source device is positioned within a region which is partitioned from the region for handling substrates obtained by dividing the interior of the inspection portion.

4. The substrate inspection apparatus according to claim 2, wherein the light source device has a configuration in which a lamp unit, in which a lamp and a housing box covering the light-emitting portion of the lamp are integrally provided, is replaceably mounted.

5. The substrate inspection apparatus according to claim 4, wherein optical components used for illumination are installed in the housing box.

6. The substrate inspection apparatus according to claim 4, wherein the lamp unit is configured to enable removal from the front portion of the apparatus opposing an inspector performing visual inspections, or from a side portion of the apparatus.

7. The substrate inspection apparatus according to claim 4, wherein the housing box has a passage enabling suction or discharge of internal air, but preventing passage of constituent components of said lamp.

8. The substrate inspection apparatus according to claim 4, wherein the housing box is connected to a duct which, by means of a fan, suctions and discharges heat and gas generated by the lamp.

9. The substrate inspection apparatus according to claim 2, wherein the inspection portion is divided into a first region, into which a hand can be inserted from an outside door to perform tasks, and a second region, in which said substrate is handled.

10. A lamp unit, in an illumination device used in a substrate inspection apparatus having an inspection portion in which the degree of cleanliness is increased compared with the outside by causing a flow of clean fluid within the apparatus, and in which a substrate is illuminated within the inspection portion and visual inspections are performed by direct observations, wherein
the lamp unit has a lamp and a housing box in which the lamp is fixed such that the light-emitting portion of the lamp is covered and on which optical components necessary for illumination are installed, and the housing box is provided with a passage enabling suction or discharge of internal air, but preventing passage of constituent components of the lamp.
